(19) United States
(12) Patent Application Publication
(10) Pub. No.: US 2018/0027364 A1
(43) Pub. Date: Jan. 25, 2018

(54) ELECTRIC VEHICLE, SERVER APPARATUS, AND COMMUNICATION INFORMATION TERMINAL

(71) Applicant: HONDA MOTOR CO., LTD., Tokyo (JP)

(72) Inventors: Tomoko Shintani, Tokyo (JP); Kanako Ikeda, Tokyo (JP); Chihiro Wake, Wako-shi (JP); Yusai Yoshimura, Wako-shi (JP)

(73) Assignee: HONDA MOTOR CO., LTD., Tokyo (JP)

(21) Appl. No.: 15/656,330

(22) Filed: Jul. 21, 2017

(30) Foreign Application Priority Data
Jul. 25, 2016 (JP) 2016-145565

(51) Int. Cl. H04W 4/00; B60H 1/00; B60L 1/00; B60L 11/18

(52) U.S. Cl. CPC H04W 4/006; B60L 11/1875; B60H 1/00735; B60L 1/00; B60K 2001/008

(57) ABSTRACT

An electric vehicle includes a power supply part provided with a temperature raising unit, a vehicle compartment environment adjustment part configured to adjust the temperature inside the vehicle, a wireless communication part to communicate with the outside of the vehicle, and a control part. Upon receiving a vehicle compartment environment adjustment command for activating the vehicle compartment environment adjustment part via the wireless communication part, the control part judges whether or not the temperature of the power supply unit exceeds a predefined temperature needed to secure enough electricity to drive the electric vehicle and, if the judgement result is negative, the control part instructs the temperature raising unit to heat up the power supply unit, and sends temperature-raising-unit activation information indicative of the activation of the temperature raising unit, to a communication information terminal, having output the vehicle compartment environment adjustment command, via the wireless communication part.

### CROSS-REFERENCE OF RELATED APPLICATION

This application claims priority of Japanese Patent Application No. 2016-145565 filed in Japan on Jul. 25, 2016, the entire contents of which are incorporated herein by reference.

### TECHNICAL FIELD

The present invention relates to an electric vehicle, a server apparatus, and a communication information terminal, and particularly relates to an electric vehicle having a unit for heating up a fuel cell or a secondary cell mounted in the vehicle, an exterior server apparatus configured to communicate with and control the electric vehicle, and a communication information terminal configured to communicate with the server apparatus or the electric vehicle.

### BACKGROUND OF THE INVENTION

An electric vehicle equipped with a fuel cell system or a large-capacity secondary cell as its power supply and running on power from this power supply has already been in practical use.

When the electric vehicle runs on power generated by the fuel cell system or an electromotive force of the secondary cell, the power supply unit is sometimes heated by warming up the fuel cell or heating up the secondary cell for smooth running of the vehicle.

In addition, when power from the power supply unit is used for a purpose other than for running to vehicle, e.g., for activating a vehicle's air conditioner, the power supply unit is heated as needed.

Meanwhile, there is proposed a system which enables activation of a vehicle's air conditioner by a fuel cell system at a place away from a vehicle (see Patent Document 1, for example). Japanese Patent Application Publication No. 2002-219926 discloses a remote air conditioning system which performs control to set the inside of the vehicle at a comfortable temperature before riding on the vehicle. The document also discloses that the system warms up a fuel cell in addition to the remote air conditioning.

Meanwhile, there is proposed a technique to perform power generation for warm-up at the time of low temperature start-up of a fuel cell system and predict time required for the warm-up (see Patent Document 2, for example). In the technique of Japanese Patent Application Publication No. 2007-188827, the fuel cell system predicts time required for the warm-up based on the minimum voltage obtained since the start of the power generation, and displays the predicted time on a display device.

Meanwhile, there is proposed a technique to notify a user that a fuel cell system is in warm-up operation for smooth activation so as to prevent the user from feeling strange or falsely recognizing the situation (see Patent Document 3, for example). In the technique of Japanese Patent Application Publication No. 2007-305346, when the fuel cell system reaches a predetermined temperature during warm-up, the system gives notification through audio as well as a message displayed on a display device.

### SUMMARY OF INVENTION

The technique of Patent Document 1 enables control on the vehicle by accessing the vehicle over the Internet using a mobile, and enables the checking of vehicle environment such as an indoor temperature from the outside.

However, it takes considerable time for the inside of the vehicle to reach a set temperature since this temperature is set. Moreover, in the case where the warm-up of the fuel cell is carried out, this warm-up also takes considerable time. For this reason, in order to check a current value of the indoor temperature or check whether the warm-up is completed, a user needs to access a server apparatus using a mobile at an appropriate timing, and such manipulation is bothersome for the user.

Meanwhile, according to the technique of Patent Document 2 or 3, since the display device constitutes a part of the fuel cell system, a user can check display on the display device only when the user rides on an electric vehicle equipped with this fuel cell system. Moreover, because this display is available through a dedicated control unit in the electric vehicle, there is a constraint that the dedicated control unit needs to be kept active in order to check display information.

The present invention has been made in view of the above circumstances, and aims to provide an electric vehicle having a power supply part (a power source) provided with a temperature raising unit and capable of letting a person easily know the end (completion) of temperature rise in the power supply part of the vehicle, an exterior server apparatus configured to communicate with and control the electric vehicle, and a communication information terminal configured to communicate with the server apparatus or the electric vehicle.

(1) An electric vehicle (the FCV1 or EV2 to be described later, for example) driven by power fed from as power supply part (the fuel cell system 11 or secondary cell 19 to be described later, for example) provided with a temperature raising unit (the unit of performing warm-up by switching the passage of gas or electric heater 19a to be described later, for example) , the vehicle including: a vehicle compartment environment adjustment part (an in-vehicle environment conditioner such as a vehicle air conditioner, e.g., the vehicle compartment environment adjustment part 15 to be described later, for example) configured to adjust the temperature inside the vehicle; a wireless (or radio) communication part (the wireless (or radio) communication part 16 to be described later, fox example) configured to communicate with the outside of the vehicle; and a control part (a controller, e.g., the control part 17 to be described later, for example), in which, upon receiving a vehicle compartment environment adjustment (conditioning) command for activating the vehicle compartment environment adjustment part via the wireless (or radio) communication part, the control part judges whether or not the temperature of the power supply unit exceeds a predefined temperature needed to secure enough electricity to drive the electric vehicle and, if the judgment result is negative, the control part instructs the temperature raising unit to heat up the power supply unit, and sends temperature-raising-unit activation information, indicative of the activation of the temperature raising unit, to a communication information terminal, being the transmission source of the vehicle compartment environment adjustment command, via the wireless (or radio) communication part.

In the electric vehicle of (1) above, irrespective of where the electric vehicle is located, a user can easily know the end of temperature rise in the power supply part of the electric vehicle which is the timing for riding on the vehicle. This increases the user's freedom in activities before riding on the vehicle.

(2) The electric vehicle of (1) above, in which the control part further sends vehicle compartment environment adjustment information indicative of an operation condition of the vehicle compartment environment adjustment part, to the communication information terminal, being the transmission source of the vehicle compartment environment adjustment command, via the wireless (or radio) communication part.

In the electric vehicle of (2) above based on the electric vehicle of (1) above, the vehicle compartment environment adjustment information is notified to the communication information terminal held by the user, in particular, only when the user activates the vehicle compartment environment adjustment part by remote control through this communication information terminal. This frees the user from the inconvenience of an excessive amount of notification information.

(3) A server apparatus (the server apparatus 20 to be described later, for example) including: a communication part (the communication part 21 to be described later, for example) configured to communicate with an electric vehicle and a communication information terminal; a storage part (the storage part 22 to be described later, for example); and a server control part (the server control part 24 to be described later, for example), in which the storage part holds terminal identification information for identifying the communication information terminal and vehicle identification information for identifying the electric vehicle according to predetermined correspondence relationship, and the server control part: sends, upon receiving from the communication information terminal a primary vehicle compartment environment adjustment command for activating a vehicle compartment environment adjustment part located in the electric vehicle and configured to adjust the temperature inside the vehicle, a secondary vehicle compartment environment adjustment command corresponding to the primary vehicle compartment environment adjustment command to the relevant electric vehicle, identified by referring to the terminal identification information and the vehicle identification information held in the storage part, via the communication part; creates, upon receiving vehicle interior environment information indicative of an environment adjustment condition inside the vehicle and temperature rise information regarding a temperature rise condition in a power supply part of the electric vehicle from the electric vehicle via the communication part, display information that enables the vehicle interior environment information and the temperature rise information to be displayed on the same screen, and sends the created display information to the communication information terminal via the communication part; and sends, upon receiving primary temperature rise end information, indicative of the end of temperature rise in the power supply part, from the electric vehicle, secondary temperature rise end information corresponding to the primary temperature rise end information to the communication information terminal vi the. communication part.

In the server apparatus of (3) above, just by uploading on the electric vehicle side the temperature rise information regarding the temperature rise condition in the power supply part and the temperature rise end information to the server apparatus, the server apparatus judges the communication information terminal to which required information is to be delivered and delivers the information to this terminal. This reduces the burden on the electric vehicle.

(4) A communication information terminal (the server control part 24 to be described later, for example) including: an input part (the input part 31 to be described later, for example) configured to accept external manipulation; a display part (the display part 32 to be described later, for example) configured to display information on a screen; a terminal communication part (the terminal communication part 33 to be described later, fox example) compatible with communication with, an electric vehicle; and a terminal control part (the terminal control part 34 to be described later, for example), in which the terminal control part: transmits, when the input part accepts manipulation for activating a vehicle compartment environment adjustment part located in the electric vehicle and configured to adjust the temperature inside the vehicle, a vehicle compartment environment adjustment command for activating the vehicle compartment environment adjustment part of the electric vehicle via the terminal communication part, and makes, upon receiving vehicle interior environment information indicative of an environment adjustment condition inside the vehicle and temperature rise information regarding a temperature rise condition in a power supply part of the electric vehicle from the electric vehicle via the terminal communication part, the display part display the vehicle interior environment information and the temperature rise information on the same screen.

In the communication information terminal of (4) above, a user can recognize the vehicle interior environment information and the temperature rise information without switching applications, which improves usability.

(5) The communication information terminal of (4) above, further including a notification part (the notification part 321 to be described later, for example) configured to give notification of the arrival of information, in which, upon receiving temperature rise end information, indicative of the end of temperature rise in the power supply part of the electric vehicle, from the vehicle via the terminal communication part, the terminal control part makes the notification part give notification of the arrival of the temperature rise end information.

In the communication information terminal of (5) above, a user can know the arrival of the temperature rise end information irrespective of whether or not the relevant application is initiated, which improves usability.

(6) An electric vehicle (the FCV1 or EV2 to be described later, for example) driven by power fed from a power supply part (11, 19) provided with a temperature raising unit, the vehicle including: a vehicle compartment environment adjustment part (the vehicle compartment environment adjustment part 15 to be described later, for example) configured to adjust the temperature inside the vehicle; a short-distance wireless (or radio) communication part (the short-distance wireless (or radio) communication part 18 to be described later, for example) configured to communicate with the outside of the vehicle; and a control part (the control part 17 to be described later, for example), in which, upon receiving a vehicle compartment environment adjustment (conditioning) signal for activating the vehicle compartment environment adjustment part via the short-distance wireless (or radio) communication part, the control part judges whether or not the temperature of the power supply unit exceeds a predefined temperature needed to secure enough electricity to drive the electric vehicle and, if the judgment result is negative, the control part instructs the temperature raising unit to heat up the power supply unit, and sends temperature-raising-unit activation information, indicative of the activation of the temperature raising unit, to a predetermined communication information terminal via the wireless (or radio) communication part.

In the electric vehicle of (6) above, once transmitting the vehicle compartment environment adjustment command with the key fob using short-distance radio transmission, for example, a user can easily know the end of temperature rise in the power supply part of the electric vehicle which is the timing for riding on the vehicle irrespective of where the electric vehicle is located. This increases the user's freedom in activities before riding on the vehicle.

### EFFECT OF THE INVENTION

The present invention can embody an electric vehicle having a power supply part provided with a temperature raising unit and capable of letting a person easily know the end of temperature rise in the power supply part of the vehicle, an exterior server apparatus configured to communicate with end control the electric vehicle, and a communication information terminal configured to communicate with the server apparatus or the electric vehicle.

### BRIEF DESCRIPTION OF THE DRAWINGS

FIG. 1 is a schematic diagram illustrating an electric vehicle, a server apparatus, and a communication information terminal as an embodiment of the present invention.

FIG. 2 is a schematic diagram illustrating an electric vehicle, a server apparatus, and a communication information terminal as a different embodiment of the present invention.

FIG. 3 is a functional block diagram illustrating the server apparatus in FIGS. 1 and 2.

FIG. 4 is a conceptual diagram representing data held in a storage part of the server apparatus in FIG. 3.

FIG. 5 is a functional block diagram illustrating the communication information terminal in FIGS. 1 and 2.

FIG. 6 is a sequence chart illustrating an example of the operations of the electric vehicle, the server apparatus, and the communication information terminal in FIGS. 1 and 2.

FIG. 7 is a flowchart illustrating a subroutine of temperature rise necessity judgment processing in the sequence chart of FIG. 6.

FIG. 8 is a flowchart illustrating a subroutine of notification destination judgment processing in the sequence chart of FIG. 6.

FIG. 9 is a schematic diagram illustrating a display example in the communication information terminal in FIGS. 1 and 2.

FIG. 10 is a schematic diagram illustrating a different display example in the communication information terminal in FIGS. 1 and 2.

FIG. 11 is a schematic diagram illustrating a still different display example in the communication information terminal in FIGS. 1 and 2.

FIG. 12 is a schematic diagram illustrating a still different display example in the communication information terminal in FIGS. 1 and 2.

FIG. 13 is a sequence chart illustrating a different example of the operations of the electric vehicle, the server apparatus, and the communication information terminal in FIGS. 1 and 2.

### DETAILED DESCRIPTION OF EMBODIMENTS OF THE INVENTION

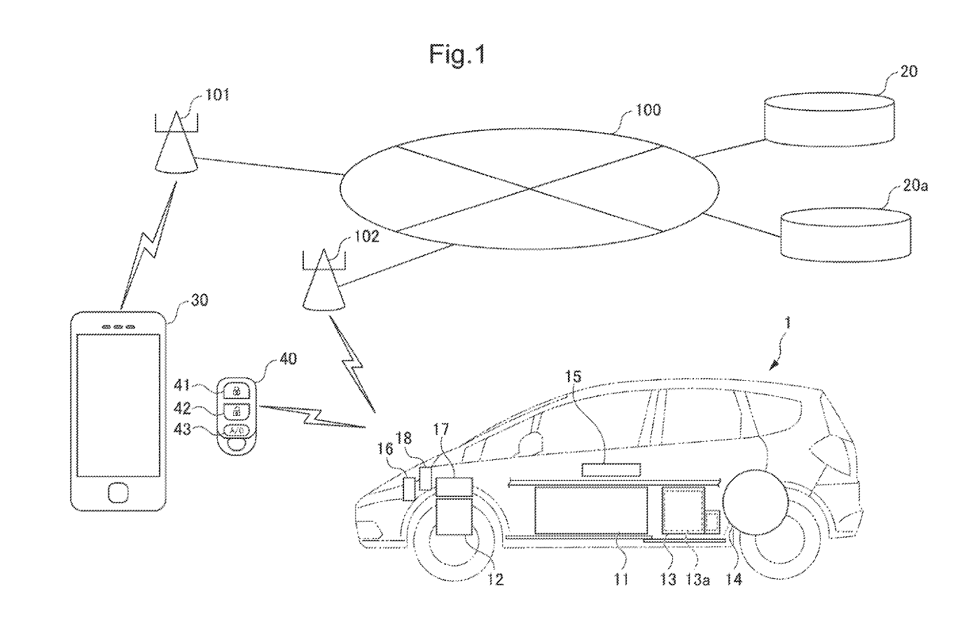

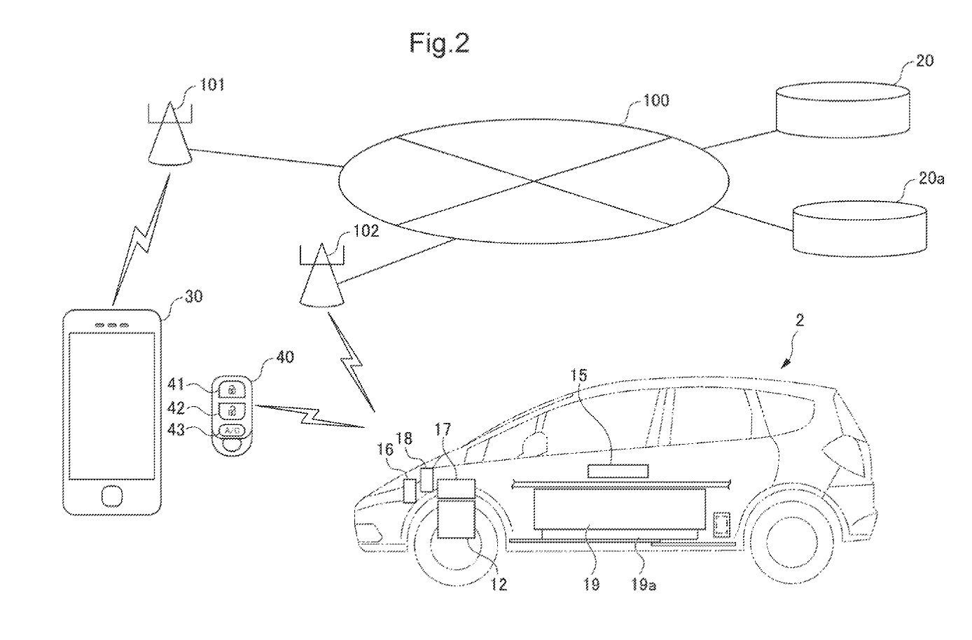

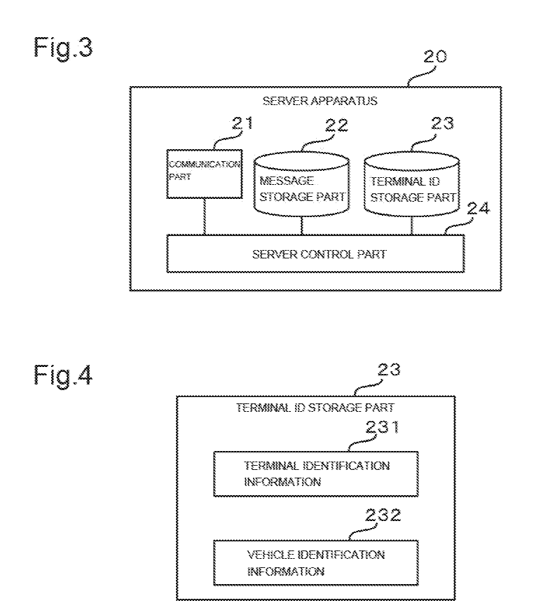

Hereinbelow, an electric vehicle, a server apparatus, and a communication information terminal as embodiments of the present invention are described in detail with reference to the drawings to clarify the present invention. Note that, in the following description, an embodiment where the electric vehicle is a fuel cell vehicle (FCV) is described with reference to FIG. 1, and a different embodiment where the electric vehicle is a battery electric vehicle (EV) is described with reference to FIG. 2. The embodiments in FIGS. 1 and 2 use in common a technique for enabling a person to easily know the end (completion) of warm-up of a fuel cell or heating of a secondary cell in the electric vehicle (FCV, EV). Thus, matters applicable to both embodiments are described with reference to FIG. 3 and subsequent drawings.

FIG. 1 is a schematic diagram illustrating the electric vehicle, the server apparatus, and the communication information terminal as the embodiment of the present invention.

The electric vehicle in FIG. 1 is a fuel cell vehicle (FCV). This fuel cell vehicle 1 includes: a fuel cell system 11 as a powersupply part (a power source); an electric motor 12 activated by power fed from the fuel cell system 11 and configured to feed wheels (e.g. front wheels) with driving force for allowing the fuel cell vehicle 1 to travel; an electrical equipment box 13 disposed behind the fuel cell system 11; and a hydrogen tank 14 disposed behind the electrical equipment box 13 to reserve hydrogen gas to be fed to the fuel cell system 11.

The fuel cell system 11 in this example is provided inside with a warm-up unit (not illustrated) configured to perform quick warm-up as required by switching passage of oxygen-containing gas or the passage of exhaust gas according to a temperature value detected by a temperature sensor. Another configuration having an electric heater as a warm-up unit instead of or in addition to the warm-up unit having the above configuration may also be employed.

Meanwhile, the electrical equipment box 13 houses therein a high-pressure battery 13a as an energy storage configured to charge and discharge power generated by the fuel cell system 11.

The fuel cell vehicle 1 is further provided with: a vehicle compartment environment adjustment part (an in-vehicle environment conditioner such as an air conditioner installed in the vehicle) 15 configured to adjust the temperature inside the vehicle; a wireless (or radio) communication part 16 configured to communicate with the outside of the vehicle; and a control part 17 configured to control the relevant parts of the fuel cell vehicle 1. For example, any of an air conditioner, a sheet heater, a glass heater, and the like corresponds to the vehicle compartment environment adjustment part 15. The wireless (or radio) communication part 16 has a telematics control unit and an antenna (not illustrated).

The control part 17 mounted in any of multiple electronic control units (ECUs), disposed in the fuel cell vehicle 1, as a part of the function part of the ECU.

Here, the fuel cell vehicle 1 is further provided with a short-distance wireless (or radio) communication part 18 configured to communicate with the outside of the vehicle using a communication method different from that of the wireless (or radio) communication part 16. The short-distance wireless (or radio) communication part 18 in the fuel cell vehicle 1 performs short-distance wireless (or radio) communication using ZigBee (registered trademark with the name ZIGBEE), Bluetooth (registered trademark with the name Bluetooth), or the like.

In FIG. 1, a server apparatus 20, a push server 20a, base stations 101 and 102 are connected to a network 100 installed outside the fuel cell vehicle 1. The wireless (or radio) communication part 16 of the fuel cell vehicle 1 can communicate with a communication information terminal 30 via the base station 102 in which the fuel cell vehicle is residing at this moment, the network 100, and the base station 101. Specifically, in FIG. 1, the base station 101 is the base station in which the communication information terminal 30 is residing at this moment. As is well known, base stations in which the fuel cell vehicle 1 (its wireless (or radio) communication part 16) and the communication information terminal 30 are currently residing are switched along with their movement to ones located relatively nearer to them.

Here, the push server 20a is also called a notification server and, in the case of FIG. 1, is a server that operates in conjunction with the server apparatus 20 in push delivery. Apple Push Notification Service (APNS) servers of Apple (registered trademark) Inc., Microsoft Push Notification Service (MPNS) servers of Microsoft (registered trademark) Corporation, Google Cloud Message (GCM) servers of Google (registered trademark.) Inc., and the like correspond to this push server 20a. Since things such as how the server apparatus 20 and the push server 20a in FIG. 1 cooperate with each other and how to split the functions among them are less relevant to the technical idea of the present invention, the server apparatus 20 and the push server 20a are hereinafter typically called the server apparatus 20.

The fuel cell vehicle 1 of this embodiment can receive manipulation signals from a key fob 40 at its short-distance wireless (or radio) communication part 18. The key fob 40 in this example has: a locking button 41 that is a manipulation button for transmitting a signal to lock the doors of the fuel cell vehicle 1; an unlocking button 42 that is also a manipulation button to unlock the doors; and an air-conditioner button 43 that is a manipulation button for transmitting a signal to activate the vehicle compartment environment adjustment part 15 (air conditioner in this case).

Next, an electric vehicle, a server apparatus, and a communication information terminal as a different embodiment of the present invention are described with reference to FIG. 2.

As described previously, the embodiment of FIG. 2 is the dame as the embodiment of FIG. 1 except that the electric vehicle is a battery electric vehicle (EV). Thus, in FIG. 2, parts corresponding to those of FIG. 1 are given the same reference numerals, and the description for these parts is omitted.

A battery electric vehicle 2 in FIG. 2 which is an electric vehicle has a large-capacity high-pressure secondary cell 19 instead of the fuel cell system 11 in the fuel cell vehicle 1 of FIG. 1. The secondary cell 19 is provided with an electric heater 19a which is a heating unit. Here, the high-pressure battery 13a (thus, the electrical equipment box 13 serving as its cover member in the fuel cell vehicle 1 of FIG. 1 is replaced with this secondary cell 19, and the battery electric vehicle 2 of FIG. 2 has neither these parts nor the hydrogen tank 14. Instead, the battery electric vehicle includes a system for charging from an external commercial power supply (not illustrated) that is capable of charging the secondary cell 19 with a plug to be inserted into an outlet and a controller.

Next, the server apparatus 20 and the communication information terminal in FIGS. 1 and 2 are described with reference to FIGS. 3, 4, and 5.

FIG. 3 is a functional block diagram illustrating the server apparatus in FIGS. 1 and 2.

FIG. 4 is a conceptual diagram representing data held in a storage part of the server apparatus in FIG. 3.

As in FIG. 3, the server apparatus 20 includes: a communication part 21 configured to communicate with the electric vehicle (FCV1, EV2) and the communication information terminal 30; a message storage part 22; a terminal ID storage part 23; and a server control part 24.

The message storage part 22 is a storage part for storing messages exchanged via the server apparatus 20.

The terminal ID storage part 23 holds terminal identification information 221 for identifying a communication information terminal and vehicle identification information 222 for identifying an electric vehicle according to predetermined correspondence relationship.

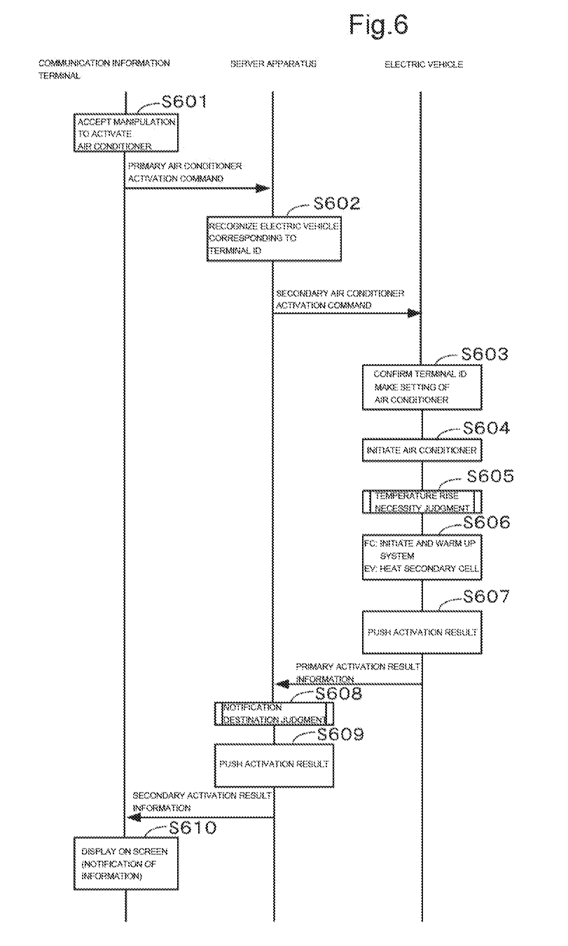

The server control part 24 will be described later with reference to FIG. 6.

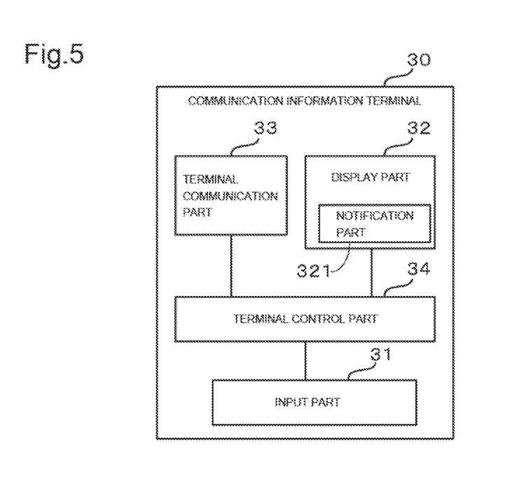

FIG. 5 is a functional block diagram illustrating the communication information terminal in FIGS. 1 and 2.

As in FIG. 5, the communication information terminal 30 includes: an input part 31; a display part 32; a terminal communication part 33; and a terminal control part 34. Since the display part 32 is a touch panel, it also functions as the input part 31; however, because FIG. 5 is a functional block diagram, these functions are represented separately as illustrated in the drawing.

The input part 31 is configured to receive external manipulation such as touch manipulation on a touch panel.

The display part 32 is configured to display information on a screen such as a liquid crystal panel. The display part 32 of the communication information terminal 30 in this embodiment also functions as a notification part 321 configured to give notification of the arrival of information having been pushed.

The terminal communication part 33 is configured to perform communication signal processing in a mode compatible with communication with the electric vehicle (FCV1, EV2).

The terminal control part 34 is configured to collectively manage the input part 31, the display part 32, and the terminal communication part 33.

Next, the operations of the communication information terminal 30, the server apparatus 20, and the electric vehicle (FCV1, EV2) are described with reference to FIG. 6.

FIG. 6 is a sequence chart illustrating an example of the operations of the electric vehicle (FCV1, EV2), the server apparatus 20, and the communication information terminal 30 in FIGS. 1 and 2.

The sequence chart in FIG. 6 illustrates the processes in which, when the vehicle compartment environment adjustment part (air conditioner in this example) 15 is activated in response to user's manipulation on the communication information terminal 30, the temperature raising unit (a temperature raising device such as a heater) provided in the power supply part of the electric vehicle (FCV1, EV2) starts to operate as required and, once the rise of temperature ends, a notice of this event is returned to the communication information terminal 30.

First user's vehicle compartment environment adjustment manipulation (manipulation to initiate the air conditioner which is the vehicle compartment environment adjustment part of the electric vehicle) on the input part 31 is accepted in the communication information terminal 30 (Step S601).

In the communication information terminal 30, in response to the user's vehicle compartment environment adjustment manipulation on the input part 31, the terminal communication part 33 creates, under control of the terminal control part 34, a primary vehicle compartment environment adjustment command (a signal according to the communication method in the communication information terminal 30, “PRIMARY AIR CONDITIONER ACTIVATION COMMAND” in the drawing) which is a vehicle compartment environment adjustment command for activating the air conditioner. This primary vehicle compartment environment adjustment command is transmitted to the server apparatus 20.

The primary vehicle compartment environment adjustment command is transmitted along the path (FIGS. 1 and 2) of the communication information terminal 30-the residing base station 101-the network 100-the server apparatus 20 in FIGS. 1 and 2.

The primary vehicle compartment environment adjustment command transmitted in this manner is received by the communication part 21 the server apparatus 20.

Upon receipt of the primary vehicle compartment environment adjustment command at the communication part 21, under administration of the server control part 24 (FIG. 3), the server apparatus 20 refers to the terminal identification information 231 and the vehicle identification information 232 held in the terminal ID storage part 23 to identify and recognize the electric vehicle (FCV1, EV2) having the air conditioner as the vehicle compartment environment adjustment part that is to be activated (Step S602).

Subsequent to Step S602, the server control part 24 creates a secondary vehicle compartment environment adjustment command (“SECONDARY AIR CONDITIONER ACTIVATION COMMAND” in the drawing) that corresponds to the received primary vehicle compartment environment adjustment command. This secondary vehicle compartment environment adjustment command includes: a command to activate the vehicle compartment environment adjustment part 15 (air conditioner) of the electric vehicle (FCV1, EV2) in a predetermined mode; and identification information (terminal ID) of the communication information terminal 30 that has originally sent this command.

The server control part 24 transmits the secondary vehicle compartment environment adjustment command described above to the electric vehicle (FCV1, EV2) identified in Step S602 via the communication part 21.

This command is transmitted along the path (FIGS. 1 and 2) of the communication part 21-the network 100-the residing base station 102-the wireless (or radio) communication part 16 of the electric vehicle-the control part 17 of the electric vehicle.

Based on the secondary vehicle compartment environment adjustment command transmitted in the above manner, the control part 17 of the electric vehicle (FCV1, EV2) confirms that the terminal ID included in this command is registered in association with this vehicle, and then makes setting to activate the vehicle compartment environment adjustment part 15 (air conditioner) in the predetermined mode (Step S603),

The control part 17 initiates the vehicle compartment environment adjustment part 15 (air conditioner) in accordance with the setting made in Step S603 (Step S604)

Next, the control part 17 judges whether or not the power supply part (the fuel cell system 11, the secondary cell 19) needs to be heated (Step S605) .

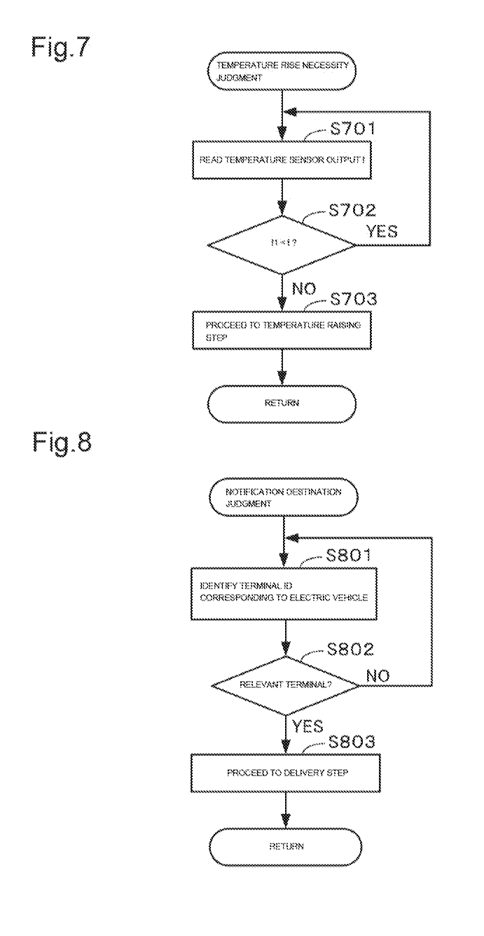

FIG. 7 is a flowchart illustrating a subroutine of temperature rise necessity judgment processing in the sequence chart of FIG. 6.

In the temperature rise necessity judgment processing, a detection output t of a temperature sensor (not illustrated) that detects the temperature of a predetermined portion of the power supply part (the fuel cell system 11, the secondary cell 19) of the electric vehicle (FCV1, EV2) is read (Step S701), and then it is judged whether or not the read value exceeds a predefined temperature t1 needed to secure enough electricity to drive the electric vehicle (FCV1, EV2) (t>t1) (Step S702). If the judgment result of Step S702 is negative (Step S702: NO), i.e., if t>t1 is satisfied, the process moves to the temperature raising step (Step S703). In other words, in this Step S703, the process moves to Step S606 in FIG. 6.

If the judgment result of Step S702 is positive (Step S702: YES), no temperature rise is required and thus the process moves back to Step S701.

After the process moves to Step S606 from the temperature rise necessity judgment subroutine (Step: S6O5), if the electric vehicle is the fuel cell vehicle (FCV) 1, the fuel cell system (FC) 11 is activated in the warm-up mode to heat it up to the predefined temperature On the other hand, if the electric vehicle is the battery electric vehicle (EV) 2, the secondary cell 19 is heated by the electric heater 19a to heat it up to the predefined temperature.

The temperature rise in the case where the electric vehicle is the battery electric vehicle (EV) 2 is performed for the purpose of improving the reduction of the capacity of the secondary cell 19 at low temperature, and the heating is done by energization from an external power supply (not illustrated), for example.

Subsequent to Step S606 the control part 17 creates, as primary activation result information, display information by which vehicle interior environment information indicative of the environment adjustment condition inside the vehicle such as the temperature of the vehicle compartment measured when the air conditioner is in operation) and temperature rise information regarding the temperature rise condition in the power supply part of the electric vehicle can be displayed on the same screen. The primary activation result information includes identification information (terminal ID) of the communication information terminal 30 to which the activation result is to be delivered. The control part 17 pushes the above primary activation result information to the server apparatus 20 (Step S607).

Specifically, in Step S607, the primary activation result information created in the above manner is pushed from the control part 17 of the electric vehicle (FCV1, EV2) along the path (FIGS. 1 and 2) of the wireless (or radio) communication part 16-the residing base station 102-the network 100-the server apparatus 20.

Upon receiving the primary activation result information in Step S607, the server apparatus 20 performs processing of judging a terminal to which this primary activation result information is to be notified (Step S608).

FIG. 8 is a flowchart illustrating a subroutine S608 of notification destination judgment processing in the sequence chart of FIG. 6. This processing performed by the server control part 24 of the server apparatus 20.

In the notification destination judgment processing, the server apparatus 20 performs processing of identifying the communication information terminal 30 having the relevant identification information (terminal ID) bused on the correspondence relationship between the terminal identification information 231 and the vehicle identification information 232 stored in the terminal ID storage part 23 of the server apparatus 20 (Step S801).

As a result of the processing in Step S801, it is judged whether or not the relevant communication information to exists (Step S802). If the relevant communication information terminal 30 is identified (Step S802: YES), the process moves to processing of pushing the result of activation of the temperature raising unit (temperature raising device) (Step S803). If it is judged in Step S802 that no relevant communication information terminal 30 is identified, the process moves back to Step S801.

After the process moves to Step S609 from the notification destination judgment subroutine (Step S608), the server control part 24 creates secondary activation result information corresponding to the primary activation result information described above. The secondary activation result information includes: display information by which vehicle interior environment information indicative of the environment adjustment condition inside the vehicle (such as the temperature of the vehicle compartment measured when the air conditioner is in operation) and temperature rise information regarding the temperature rise condition in the power supply part of the electric vehicle can be displayed on the same screen; and identification information (terminal ID) of the communication information terminal 30 to which the activation result is to be delivered.

The server control part 24 creates the secondary activation result information in the above manner and pushes this secondary activation result information to the communication information terminal 30 (Step S609).

Specifically, in Step S609, the secondary activation result information created in the above manner is transmitted from the server control part 24 of the server apparatus 20 to the communication information terminal 30. This information is transmitted along the path (FIGS. 1 and 2) of the communication part 21-the network 100-the residing base station 101-the communication information terminal 30.

Under administration of the terminal control part 34, the communication information terminal 30 having received the secondary activation result information thus pushed in Step S609 displays, on the display part 32, information based on the above display information included in the secondary activation result information. In this event, in the display part 32, the vehicle interior environment information and the temperature rise information described above are displayed on the same screen.

Here, the electric vehicle (FCV1, EV2) transmits temperature rise end information indicative of the end of temperature rise, which is information obtained when the temperature rise condition in the power supply part of the electric vehicle is identified, along the information transmission path as in the above (FIGS. 1 and 2) of the electric vehicle (FCV1, EV2)-the residing base station 102-the network 100-the server apparatus 20-the network 100-the residing base station 101-the communication information terminal 30. Upon receiving the temperature rise end information, indicative of the end of temperature rise in the power supply part of the electric vehicle, from the vehicle via the terminal communication part 33, the terminal control part 34 of the communication information terminal 30 makes the notification part 321 give notification of the arrival of the temperature rise end information.

Here, how information is displayed in the communication information terminal 30 is exemplified using the drawings.

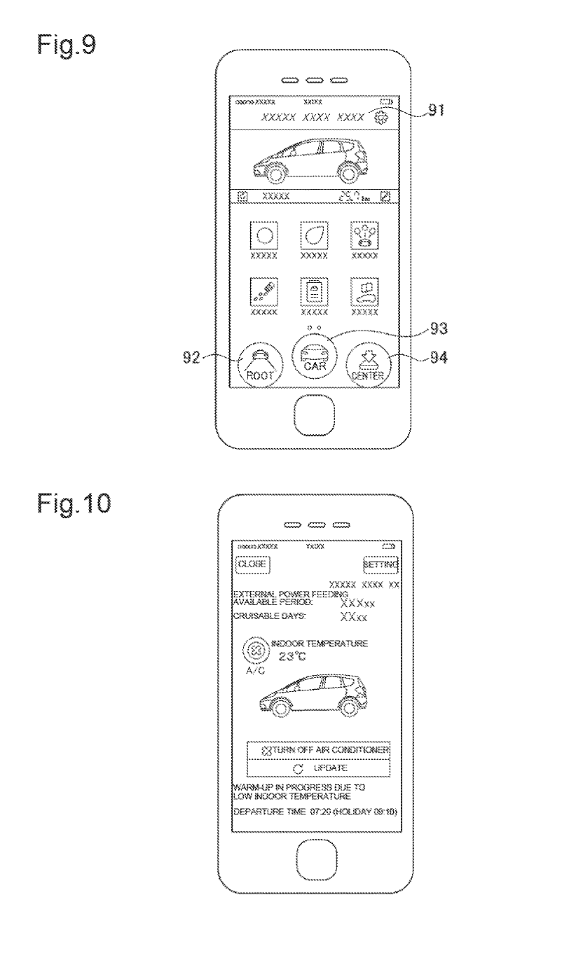

FIG. 9 is a schematic diagram illustrating a display example in the communication information terminal in FIGS. 1 and 2. In particular, FIG. 9 schematically illustrates a display example at the time of initiating an app to activate the vehicle compartment environment adjustment part such as the air conditioner of the electric vehicle by manipulation through the communication information terminal 30.

In FIG. 9, a name 91 of the app is displayed in an upper part of the screen. In addition, on the lower side of the screen, a button 92 to check the route suggested by the car navigation, a button 93 to check the operation condition of the vehicle compartment environment adjustment part such as the air conditioner of the electric vehicle, and a button 94 to check, e.g., a record of delivered messages to the electric vehicle stored in the message storage part of the server apparatus described above are displayed.

FIG. 10 is a schematic diagram illustrating a different display example in the communication information terminal in FIGS. 1 and 2.

This FIG. 10 exemplifies a display screen that appears by tapping on the button 93 in the display screen of the communication information terminal 30 in FIG. 9.

As can be read from FIG. 10, various conditions including the operation condition of the vehicle compartment environment adjustment part such as the air conditioner of the electric vehicle are displayed on the screen as vehicle information. In particular, the information that the fuel cell system is in warm-up operation due to the low temperature of the vehicle (and its fuel cell system) in response to, or not in response to, the activation of the vehicle compartment environment adjustment part such as the air conditioner of the electric vehicle described above is displayed on the lower side of the screen.

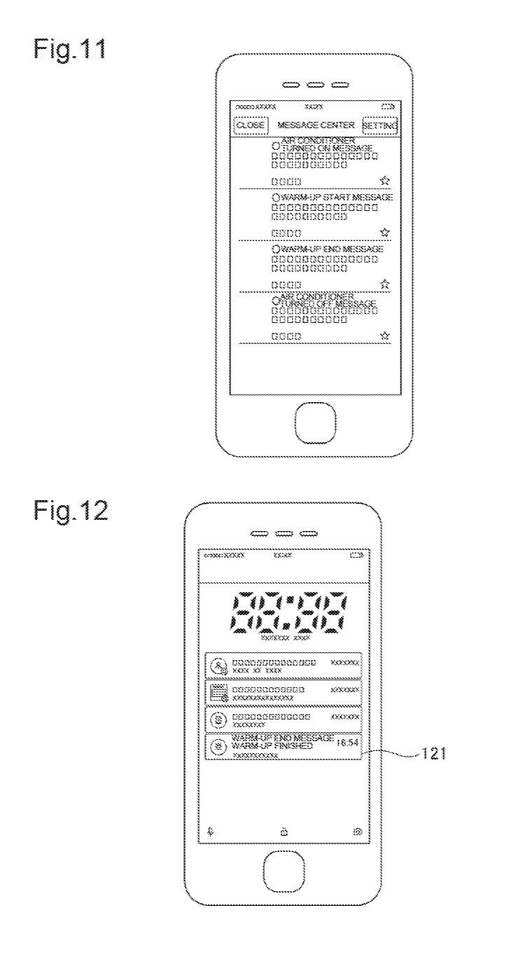

FIG. 11. is a schematic diagram illustrating a still different display example in the communication information terminal in FIGS. 1 and 2.

This FIG. 11 exemplifies a display screen that appears by tapping on the button 94 in the display screen of the communication information terminal 30 in FIG. 9.

As can be read from FIG. 11, the record of delivered messages to the electric vehicle is displayed on this screen.

FIG. 12 is a schematic diagram illustrating a still different display example in the communication information terminal in FIGS. 1 and 2.

In this FIG. 12, a display 121 of the notification part 321 as a function part of the above display part 32 of the communication information terminal 30 is visually recognized. Specifically, when the terminal control part 34 of the communication information terminal 30 receives temperature rise end information, indicative of the end of temperature rise in the power supply part of the electric vehicle, from the electric vehicle via the terminal communication part 33, the communication information terminal makes the notification part 321 give notification of the arrival of the temperature rise end information. The display 121 in FIG. 12 shows this arrival notification. In other words, a user can know the end of temperature rise without keeping the application 91 illustrated in FIGS. 9 and 10 displayed on the screen.

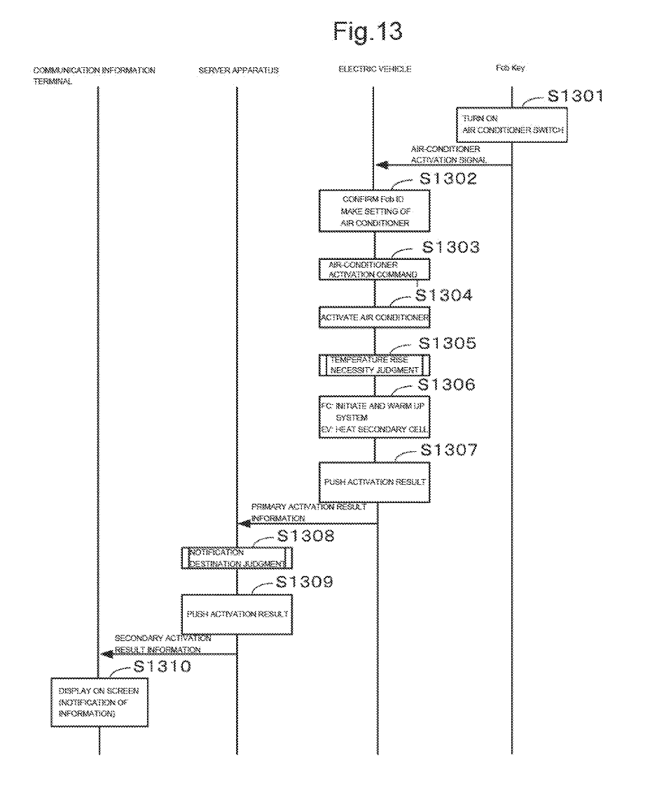

Next, a different example of the operations of the electric vehicle, the server apparatus, and the communication information terminal in FIGS. 1 and 2 is described with reference to FIG. 13.

FIG. 13 is a sequence chart illustrating the different example of the operations of the electric vehicle, the server apparatus, and the communication information terminal in FIGS. 1 and 2.

With reference to FIG. 6, a description has already been given of the operations in which, when the vehicle compartment environment adjustment part (air conditioner in this example) 15 is activated in response to user's manipulation on the communication information terminal 30, the temperature raising unit provided in the power supply part of the electric vehicle (FCV1, EV2) starts to operate as required and, once the rise of temperature ends, a notice of this event is returned to the communication information terminal 30.

Hereinbelow, with reference to FIG. 13, a description is given of the operations in which, when the vehicle compartment environment adjustment part (air conditioner in this example) 15 is activated in response to user's manipulation on the key fob 40 (FIGS. 1 and 2), the temperature raising unit provided in the power supply part of the electric vehicle (FCV1, EV2) starts to operate as required and, once the rise of temperature ends, a notice of this event is returned to the communication information terminal 30.

When the air-conditioner button 43 of the key fob 40 (FIGS. 1 and 2) is pushed by a user (Step S1301) an air-conditioner activation signal for activating the air conditioner as the vehicle compartment environment adjustment part 15 is transmitted from the key fob 40 to the electric vehicle (FCV1, EV2).

Specifically, the air-conditioner activation signal output from the key fob 40 is directly transmitted to the short-distance wireless (or radio) communication part 18 of the electric vehicle (FCV1, EV2). This air-conditioner activation signal includes a fob ID for identifying the key fob 40 itself.

When the electric vehicle (FCV1, EV2) receives the air-conditioner activation signal at the short-distance wireless (or radio) communication part 18, the control part 17 checks using the fob ID that the key fob 40 having output the air-conditioner activation signal is an authorized key for this vehicle, and then makes setting to activate the vehicle compartment environment adjustment part 15 (air conditioner) in the predetermined mode (Step S1302).

Next, the control part gives an air-conditioner activation command to the air conditioner as the vehicle compartment environment adjustment part 15 in accordance with the setting made in Step S1302 (Step S1303). In response to this command, the air conditioner enters in operation (Step S1304).

Subsequently, the control part 17 judges whether or not the power supply part (the fuel cell system 11, the secondary cell 19) needs to be heated (Step S1305).

The subroutine of temperature rise necessity judgment processing in Step S1305 is the same as that in the flowchart in FIG. 7 described above. Thus, the description made in FIG. 6 is invoked to describe the processing in Step S1305.

After the process moves to Step S1306 from the temperature rise necessity judgment subroutine (Step S1305), if the electric vehicle is the fuel cell vehicle (FCV) 1, the fuel cell system (FC) 11 is activated in the warm-up mode to heat it up to the predefined temperature. On the other hand, if the electric vehicle is the battery electric vehicle (EV) 2, the secondary cell 19 is heated by the electric heater 19a to heat it up to the predefined temperature.

Subsequent to Step S1306, the control part 17 creates, as primary activation result information, display information by which vehicle interior environment information indicative of the environment adjustment condition inside the vehicle (such as the temperature of the vehicle compartment measured when the air conditioner is in operation) and temperature rise information regarding the temperature rise condition in the power supply part of the electric vehicle can be displayed on the same screen. The primary activation result information includes identification information (terminal ID) of the communication information terminal 30 to which the activation result is to be delivered. The control part 17 pushes the above primary activation result information to the server apparatus 20 (Step S1307).

Specifically, in Step S1307, the primary activation result information created in the above manner is pushed from the control part 17 of the electric vehicle (FCV1, EV2) along the path (FIGS. 1 and 2) of the wireless (or radio) communication part 16-the residing base station 102-the network 100-the server apparatus 20.

Upon receiving the activation result information in Step S1307, the server apparatus 20 performs processing of judging a terminal to which this primary activation result information is to be notified (Step S1308).

The subroutine of notification destination judgment processing in Step S1308 is the same as that in the flowchart in FIG. 8 described above. Thus, the description made in FIG. 8 is invoked to describe the processing in Step S1308.

After the process moves to Step S1309 from the notification destination judgment subroutine (Step S1308), the server control part 24 creates secondary activation result information corresponding to the primary activation result information described above. The secondary activation result information includes: display information by which vehicle interior environment information indicative of the environment adjustment condition inside the vehicle (such as the temperature of the vehicle compartment measured when the air conditioner is in operation) and temperature rise information regarding the temperature rise condition in the power supply part of the electric vehicle can be displayed on the same screen; and identification information (terminal ID) of the communication information terminal 30 to which the activation result is to be delivered.

The server control part 24 creates the secondary activation result information in the above manner and pushes this secondary activation result information to the communication information terminal 30 (Step S1309).

Specifically, in Step S1309, the secondary activation result information created in the above manner is transmitted from the server control part 24 of the server apparatus 20 to the communication information terminal 30. This information is transmitted along the path (FIGS. 1 and 2) of the communication part 21-the network 100-the residing base 101-the communication information terminal 30.

Under administration of the terminal control part 34, the communication information terminal 30 having received the secondary activation result information thus pushed in Step S1309 displays, on the display part 32, information based on the above display information included in the secondary activation result information. In this event, in the display part 32, the vehicle interior environment information and the temperature rise information described above are displayed on the same screen.

Here, the electric vehicle (FCV1, EV2) transmits temperature rise end information indicative of the end of temperature rise along the information transmission path as in the above (FIGS. 1 and 2) of the electric vehicle (FCV1, EV2)-the residing base station 102-the network 100-the server apparatus 20-the network 100-the residing base station 101-the communication information terminal 30. Specifically, the temperature rise end information is information obtained when the temperature rise condition in the power supply part of the electric vehicle is identified. Upon receiving the temperature rise end information, indicative of the end of temperature rise in the power supply part of the electric vehicle, from the vehicle via the terminal communication part 33, the terminal control part 34 of the communication information terminal 30 makes the notification part 321 give notification of the arrival of the temperature rise end information.

The operations and effects of this embodiment described above are summarized.

(1) The electric vehicle (FCV1, EV2) of this embodiment is the electric vehicle driven by power fed from the power supply part, which is the fuel cell system 11 or the secondary cell 19, provided with the unit of performing warm-up by switching the passage of gas in the case of the FCV1 or the temperature raising unit such as the electric heater 19a in the case of the EV2. This electric vehicle includes: the air conditioner as the vehicle compartment environment adjustment part 15 configured to adjust the temperature inside the vehicle; the wireless (or radio) communication part 16 configured to communicate with the outside of the vehicle; and the control part 17. In the electric vehicle, upon receiving a vehicle compartment environment adjustment command for activating the air conditioner 15 via the wireless (or radio) communication part 16, the control part 17 judges whether or not the temperature of the power supply unit (11, 19) exceeds a predefined temperature needed to secure enough electricity to drive the electric vehicle. If the judgment result is negative, the control part instructs the temperature raising unit to heat up the power supply unit (11, 19), and sends temperature-raising-unit activation information, indicative of the activation of the temperature raising unit, to the communication information terminal, being the transmission source of the vehicle compartment environment adjustment command, via the wireless (or radio) communication part 16.

In the electric vehicle (FCV1, EV2) of (1) above, irrespective of where the electric vehicle (FCV1, EV2) is located, a user of the electric vehicle (FCV1, EV2) and the communication information terminal 30 can easily know the end of temperature rise in the power supply part of the electric vehicle which is the timing for riding on the vehicle. This increases the user's freedom in activities before riding on the vehicle.

(2) In the electric vehicle of (1) above, in particular, the control part 17 further sends vehicle compartment environment adjustment information, indicative of the operation condition of the air conditioner as the vehicle compartment environment adjustment part 15, to the communication information terminal 30, being the transmission source of the vehicle compartment environment adjustment command, via the wireless (or radio) communication part 16.

In the electric vehicle (FCV1, EV2) of (2) above, the vehicle compartment environment adjustment information is notified to the communication information terminal 30 held by the user only when the user activates the air conditioner 15 by remote control through this communication information terminal 30. This frees the user from the inconvenience of an excessive amount of notification information.

(3) The server apparatus 20 of this embodiment is the server apparatus 20 including: the communication part 21 configured to communicate with the electric vehicle (FCV1, EV2) and the communication information terminal 30; the message storage part 22; the terminal ID storage part 23; and the server control part 24. In the server apparatus, the terminal ID storage part 23 holds the terminal identification information 231 for identifying the communication information terminal 30 and the vehicle identification information 232 for identifying the electric vehicle (FCV1, EV2) according to the predetermined correspondence relationship. Upon receiving from the communication information terminal 30 a primary vehicle compartment environment adjustment command for activating the air conditioner as the vehicle compartment environment adjustment part 15 located in the electric vehicle and configured to adjust the temperature inside the vehicle, the server control part 24 sends a secondary vehicle compartment environment adjustment command corresponding to the primary vehicle compartment environment adjustment command to the relevant electric vehicle (FCV1, EV2), identified by referring to the terminal identification information 231 and the vehicle identification information 232 held in the terminal ID storage part 23, via the communication part 21. Upon receiving vehicle interior environment information indicative of the environment adjustment condition inside the vehicle and temperature rise information regarding the temperature rise condition in the power supply part of the electric vehicle (FCV1, EV2) from the electric vehicle (FCV1, EV2) vie the communication part 21, the server control part creates display information that enables the vehicle interior environment information and the temperature rise information to be displayed on the same screen, and sends the created display information to the communication information terminal 30 via the communication part 21. Upon receiving primary temperature rise end information, indicative of the end of temperature rise in the power supply part, from the electric vehicle (FCV1, EV2), the server control part sends secondary temperature rise end information corresponding to the primary temperature rise end information to the communication information terminal 30 via the communication part 21.

In the server apparatus 20 of (3) above, just by uploading on the electric vehicle (FCV1, EV2) side the temperature rise information regarding the temperature rise condition in. the power supply part and, the temperature rise end information to the server apparatus 20, the server apparatus 20 judges the communication information terminal 30 to which required information is to be delivered and delivers the information to this terminal. This reduces the burden on the electric vehicle (FCV1, EV2).

(4) The communication information terminal 30 of this embodiment is the communication information terminal 30 including the input part 31 configured to accept external manipulation; the display part 32 configured to display information on the screen; the terminal communication part 33 compatible with communication with the electric vehicle (FCV1, EV2); and the terminal control part 34. When the input part 31 accepts manipulation for activating the air conditioner as the vehicle compartment environment adjustment part 15 located in the electric vehicle (FCV1, EV2) and configured to adjust the temperature inside the vehicle, the terminal control part 34 transmits a vehicle compartment environment adjustment command for activating the air conditioner 15 of the electric vehicle (FCV1, EV2) via the terminal communication part 33. Upon receiving vehicle interior environment information indicative of the environment adjustment condition inside the vehicle and temperature rise information regarding the temperature rise condition in the power supply part of the electric vehicle (FCV1, EV2) from the electric vehicle (FCV1, EV2) via the terminal communication part 33, the terminal control part makes the display part 32 display the vehicle interior environment information and the temperature rise information on the same screen.

In the communication information terminal 30 of (4) above, a user can recognize the vehicle interior environment information and the temperature rise information without switching applications, which improves usability.

(5) In particular, the communication information terminal of (4) above further includes the notification part 321 configured to give notification of the arrival of information and, upon receiving temperature rise end information, indicative of the end of temperature rise in the power supply part of the electric vehicle (FCV1, EV2), from the vehicle via the terminal communication part 33, the terminal control part 34 makes the notification part 321 give notification of the arrival of the temperature rise end information.

In the communication information terminal 30 of (5) above, a user can know the arrival of the temperature rise end information irrespective of whether or not the relevant application is initiated, which improves usability.

(6) The electric vehicle (FCV1, EV2) of this embodiment is the electric vehicle (FCV1, EV2) driven by power fed from the power supply part (11, 19) provided with the temperature raising unit. This electric vehicle includes: the air conditioner as the vehicle compartment environment adjustment part 15 configured to adjust the temperature inside the vehicle; the short-distance wireless (or radio) communication part 18 configured to communicate with the outside of the vehicle; and the control part 17. In the electric vehicle, upon receiving a vehicle compartment environment adjustment signal for activating the air conditioner 15 via the short-distance wireless (or radio) communication part 18, the control part 17 judges whether or not the temperature of the power supply unit (11, 19) exceeds a predefined temperature needed to secure enough electricity to drive the electric vehicle (FCV1, EV2). If the judgment result is negative, the control part instructs the temperature raising unit to heat up the power supply unit (11, 19), and sends temperature-raising-unit activation information, indicative of the activation of the temperature raising unit, to the predetermined communication information terminal 30 via the wireless (or radio) communication part 16.

In the electric vehicle (FCV1, EV2) of (6) above, once transmitting the vehicle compartment environment adjustment command with the key fob (40) using short-distance radio transmission, for example, a user can easily know the end of temperature rise in the power supply part (11, 19) of the electric vehicle (FCV1, EV2) which is the timing for riding on the vehicle irrespective of where the electric vehicle is located. This increases the user's freedom in activities before riding on the vehicle.

In addition to the above embodiment, various alternatives and modifications not departing from the gist of the present invention are included within the scope of the present invention.

For example, while the electric vehicle of the present invention has been described with the example in which its vehicle compartment environment adjustment part is typically the air conditioner, the vehicle compartment environment adjustment part is not limited to this, and a seat heater, a glass heater, a defroster, or the like also corresponds to the vehicle compartment environment adjustment part. The aspects of the present invention can be exhibited also when these are used as the vehicle compartment environment adjustment part.

### DESCRIPTION OF REFERENCE NUMERALS

1 ELECTRIC VEHICLE (FUEL CELL VEHICLE)

2 ELECTRIC VEHICLE (BATTERY ELECTRIC VEHICLE)

11 FUEL CELL SYSTEM

15 VEHICLE COMPARTMENT ENVIRONMENT ADJUSTMENT PART

16 WIRELESS (OR RADIO) COMMUNICATION PART

17 CONTROL PART

18 SHORT-DISTANCE WIRELESS (OR RADIO) COMMUNICATION PART

19 SECONDARY CELL

20 SERVER APPARATUS

21 COMMUNICATION PART

22 MESSAGE STORAGE PART

23 TERMINAL ID STORAGE PART

24 SERVER CONTROL PART

30 COMMUNICATION INFORMATION TERMINAL

31 INPUT PART

32 DISPLAY PART

33 TERMINAL COMMUNICATION PART

34 TERMINAL CONTROL PART

321 NOTIFICATION PART

1. An electric vehicle driven by power supplied from a power source provided with a temperature raising device to raise a temperature of the power source, said. vehicle comprising:
an in-vehicle environment conditioner configured to adjust a temperature inside said vehicle;
a wireless communicator configured to communicate with a communication information terminal which is outside said vehicle; and
a controller configured to activate said in-vehicle environment conditioner upon receiving an in-vehicle environment conditioning command from said communication information terminal via said wireless communicator, wherein
when said controller receives the in-vehicle environment conditioning command, said controller determines whether or not the temperature of said power source exceeds a predefined temperature which is needed to secure enough electricity to drive said electric vehicle, and
when it is determined that the temperature of said power source does not exceed the predefined temperature, said controller activates said temperature raising device to heat up said power source and sends information indicative of the activation said temperature raising device, to said communication information terminal.

2. The electric vehicle according to claim 1, wherein said controller further sends in-vehicle environment condition information which indicates an operation condition of said in-vehicle environment conditioner, to said communication information terminal via said wireless communication part.

3. A server apparatus comprising:
a communicator configured to communicate with an electric vehicle and a communication information terminal for said electric vehicle;
a storage part that stores therein terminal identification information for identifying said communication information terminal and vehicle identification information for identifying said electric vehicle to identify the electric vehicle corresponding to the terminal according to predetermined correspondence relationship therebetween; and
a server controller configured to
receive from said communication information terminal a primary in-vehicle environment conditioning command for activating an in-vehicle environment conditioner which is installed in said electric vehicle and configured to adjust a temperature inside said vehicle;
upon receiving said a primary in-vehicle environment conditioning command, identify said corresponding electric vehicle by referring to the terminal identification information and the vehicle identification information stored in said storage part and send a secondary in-vehicle environment conditioning command corresponding to the primary in-vehicle environment conditioning command to said corresponding electric vehicle via said communicator.;
upon receiving in-vehicle environment information indicating an environment condition inside said vehicle and power source temperature information indicating a temperature condition in a power source of said electric vehicle from said electric vehicle via said communicator, generate information for display that enables both the vehicle interior environment information and the power source temperature information to be displayed on one screen, and send the generated information for display to said communication information terminal via said communication part; and
upon receiving primary power source temperature rise completion information indicative of a completion of temperature rise in said power source from said electric send secondary temperature rise completion information corresponding to the primary temperature rise completion information to said communication information terminal via said communicator.

4. A communication information terminal comprising:
an input part configured to be operable by a user;
a display part configured to display information on a screen;
a terminal communication part configured to perform communication with an electric vehicle; and
a terminal controller configured to:
transmit, when said input part receives an operation for activating an in-vehicle air conditioner installed in said electric vehicle and configured to adjust a temperature inside said vehicle, an in-vehicle environment conditioning command for activating said in-vehicle environment conditioner of said electric vehicle via said terminal communication part; and
upon receiving in-vehicle environment information of an environment condition inside said vehicle and power source temperature information indicating a temperature condition in a power source of said electric vehicle from said electric vehicle via said terminal communication part, cause said display part to display the vehicle interior environment information and the power source temperature information on one screen.

5. The communication information terminal according to claim 4, further comprising a notification part configured to give notification of receipt of information,
wherein, upon receiving temperature rise completion information indicating a completion of temperature rise in said power source of said electric vehicle, from said vehicle via said terminal communication part, said terminal control part causes said notification part to give the notification of the receipt of the temperature rise completion information.

6. An electric vehicle driven by power supplied from a power source provided with a temperature raising device, said vehicle comprising:
an in-vehicle environment conditioner configured to adjust a temperature inside said vehicle;
a wireless communicator configured to communicate with a communication information terminal of a user which is outside said vehicle;
a short-distance wireless communicator configured to communicate with the user which is outside said vehicle and to receive an in-vehicle environment conditioning signal for activating said in-vehicle air conditioner; and
a controller configured to activate said in-vehicle environment conditioner upon receiving said in-vehicle environment conditioning signal via said short -distance wireless communicator, wherein
when said controller receives the in-vehicle environment conditioning signal, said controller determines whether or not a temperature of said power source exceeds a predefined temperature needed to secure enough electricity to drive said electric vehicle, and
when it is determined that the temperature of said power source does not exceed the predefined temperature, said controller activates said temperature raising device to heat up said power source and sends information indicative of the activation of said temperature raising device, to said predetermined communication information terminal via said wireless communicator.
